(19) United States
(12) Patent Application Publication
(10) Pub. No.: US 2005/0097140 A1
(43) Pub. Date: May 5, 2005

(54) Method for processing data streams divided into a plurality of process steps

(76) Inventor: Patrik Jarl, Farsta (SE)

Correspondence Address: ERICSSON INC., 6300 LEGACY DRIVE, M/S EVR C11, PLANO, TX, 75024, US

(21) Appl. No.: 10/507,357

(22) PCT Filed: Mar. 22, 2002
(86) PCT No.: PCT/SE02/00570

(51) Int. Cl. G06F 12/00

(52) U.S. Cl. 707/200

(57) ABSTRACT

The present invention relates to a processing unit (100) and a method for processing a plurality of data streams by an algorithm divided into a plurality of Process Steps (PS) comprising: an interconnection unit (102) comprising means for switching, Process Step (PS) means (106) comprising at least two PS modules (106a-106m), each connected to the interconnection unit (102) and a scheduler (110) connected to said interconnection unit (102) and to each PS module (106a-106m), wherein said processing unit (100) comprises: a memory unit (108) comprising at least two memories (108a-108n) wherein each memory is connected to the interconnection unit (102); the interconnection unit (102) comprising further means for at least providing a first connection between one of said memories and one of said PS modules and a second connection between another of said memories and another of said PS modules, wherein the interconnection unit (102) is adapted to connect each memory to each of the PS modules by a switching activity, wherein the switching activity and the processing of the PS modules is controlled by the scheduler (110); and each memory comprises means for storing a data stream and said data streams are manipulated in parallel by the connected PS modules respectively, during a predetermined time period between said switching activities.

### FIELD OF THE INVENTION

The present invention relates to a processing unit.

In particular, it relates to a processing unit and a method for resource efficient processing and calculations of complex algorithms of multiple data streams.

### BACKGROUND OF THE INVENTION

Implementation of a function comprising a complex algorithm, such as in speech coding/decoding for a speech channel, requires a high number of arithmetic operations such as multiplication, summation and subtraction, especially when several speech channels have to be processed simultaneously. The data is normally processed in different steps, e.g. pre-scaling unit, low pass filter, high pass filter, voice activity detector, code book search gain quantifier, post processors, etc. In a speech coder, several channels have to be processed, i.e. encoded/decoded, during a limited time period. E.g, if K channels have to be processed within L s, it is implied that a new channel has to enter a processing unit every L/K s. The functions processing each channel require a number of operations as mentioned above, and the functions may require a different number of clock cycles to perform their operations. A problem is how to easily divide and group the functions to be able to perform the required operations, preferably in parallel, within a limited predetermined time period, and particularly when there exists a reference model in a software language (c, Pascal etc.). All the processing is normally independent manipulation of the data stream.

Normally, implementations are performed by digital signal processing units, which are running the software algorithm, or having a microprocessor feeding an arithmetic unit with parallel data. Only simple algorithms are usually implemented directly in hardware without a micro processor.

U.S. Pat. No. 6,314,393 disclose a known method for performing processing in parallel. A parallel/pipeline VLSI architecture for a coder/decoder is described.

U.S. Pat. No. 6,201,488 shows a coder/decoder adapted to perform different algorithms. An algorithm is divided into smaller portions, called programs, where each program requires a program memory and a processor. One program operates on a data unit located on a predetermined memory position and it is not possible to perform parallel operations. In addition, it is not possible to perform both a read and a write operation during one clock cycle. The programs may require different time for their calculations and in order to perform calculations in cycles a waiting time (“idling operation”) is introduced. The waiting time is used for swapping the data units.

The drawback with the solutions described above, is that it is not possible to process a large number of data sets by time consuming and complex algorithm within an enough short time period.

Thus, an object of the present invention is to create a processing unit and a method adapted to process a plurality of data streams, e.g. a speech channels, by an algorithm within a limited predetermined time period.

### SUMMARY OF THE INVENTION

The above-mentioned objects are achieved by the present invention according to the independent claims by a method having the features of claim 1 and 9.

Preferred embodiments are set forth in the dependent claims.

An advantage with the present invention is that it provides a resource effective way of performing an algorithm in parallel without requiring a duplication of similar units. I.e. the present invention is in particular suitable for a plurality of streams of data that require similar processing, but not necessarily identical processing.

Another advantage with the present invention is that it is independent of the order in which the data streams are accessed. The process steps are able to read or write in the memories within the memory unit in arbitrary order independent of other process steps as long as the end product is correct at the end of each process step when the switching activity occurs.

Another advantage with the present invention is that it provides a way to place circuits on the unit in an advantageously way. By dividing an algorithm into process steps it facilitates placing of different units arranged for hardware implementations and signal routing, which are important for Application Specific Integrated Circuits (ASICs) and Field Programmable Gate Arrays (FPGAs). The present invention facilitates separation of an algorithm into separate circuits, where each circuit corresponds to one process step. This is suitable for FPGAs that does not comprise as high gate capacity as an ASIC.

Another advantage with the present invention is that no micro processor is used which implies that no program memory is required. Thus all processing is performed by means of customized hardware.

Another advantage with the present invention is the number of movements of data is reduced within the hardware and if the entire processing unit is implemented within a single circuit it is possible to use a memory with one or several read and write ports allowing multiple read and write accesses during a single clock cycle.

Yet another advantage with present invention is that several channels are processed simultaneously and periodic by the function.

A further advantage with the present invention is that it is suitable for creating periodic data e.g. processing of multiple data streams in different applications.

A further advantage is that the present invention facilitates debugging if a complex algorithm is divided into smaller process steps according to the invention. This division provides also a gain at the development of the process unit.

A further advantage with the present invention is that it comprises distributed separated memories. By using separated memories, it is possible to adapt the location of the memories dependent of e.g. power distribution facilities.

### BRIEF DESCRIPTION OF THE APPENDED DRAWINGS

FIG. 1 illustrates a processing unit according to the present invention.

FIG. 2a-f illustrates a method according to the present invention.

### DETAILED DESCRIPTION OF PREFERRED EMBODIMENTS

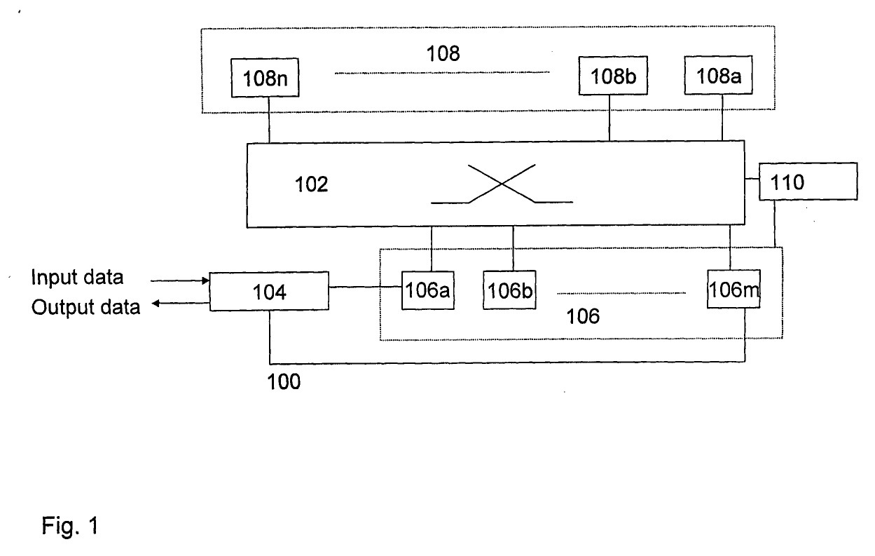

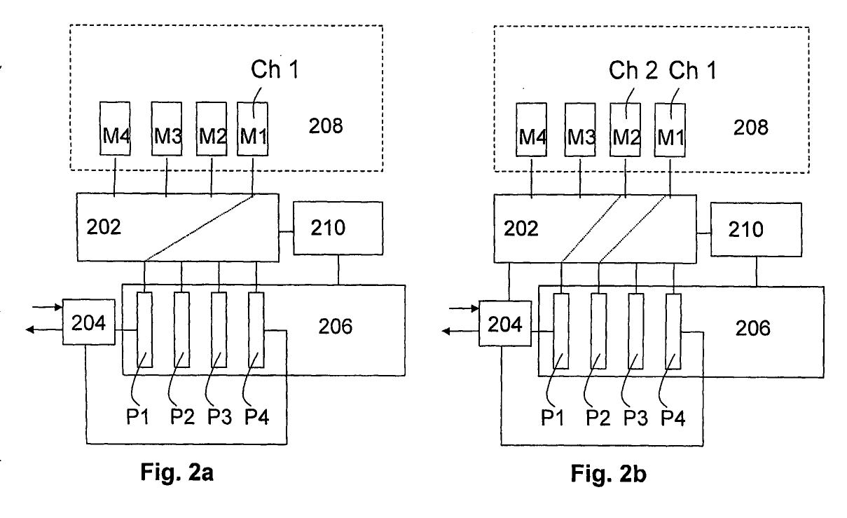

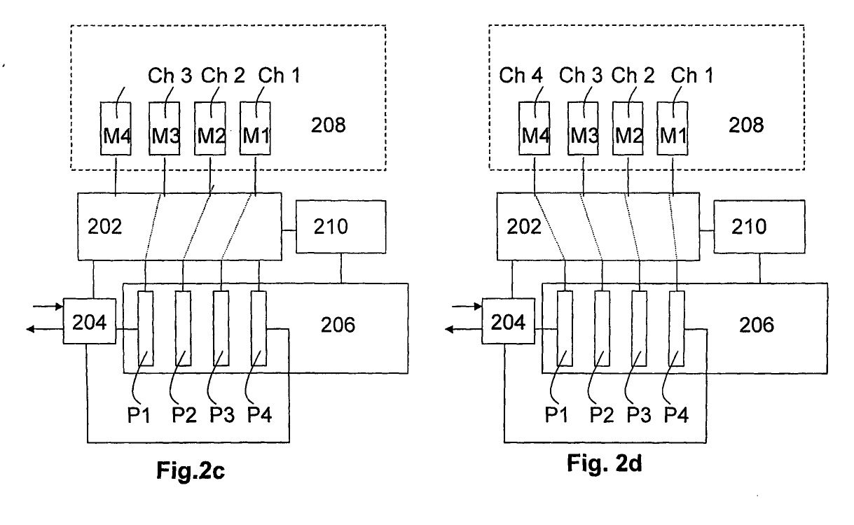

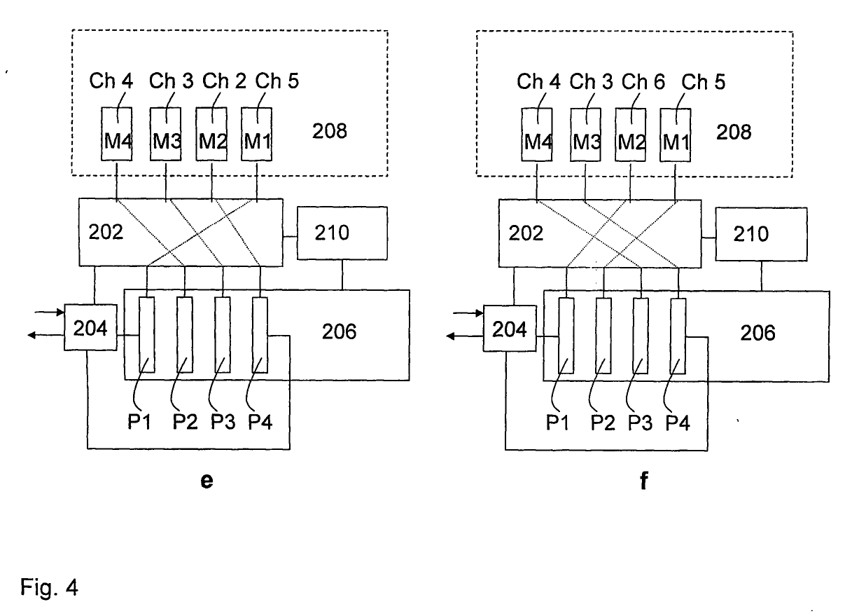

Preferred embodiments of the present invention will now be described with reference to FIGS. 1 to 2. FIG. 1 shows a processing unit 100 in accordance with the present invention. The processing unit 100 comprises an interconnection unit 102 adapted to switch memory access signals. The interconnection unit 102 is preferable a space switch or a space rotator 102, and the interconnection unit 102 is connected to a Processing means 106 comprising at least two Process Step (PS) modules 106a-106m, to at least two memories M1 108a-108n in a memory unit 108 wherein n denotes the number of memories in the memory unit 108 and m denotes the number of PS modules 106a-m. At least one external memory 104 is connected to at least one PS provided that the PS controls the data movements. It should be noted that if the process steps do not control the data movements, then the external memory is connected to the interconnection unit and it is required that the number of memories exceeds the number of PS by one or two. The external memory 104 is adapted to store e.g. input and output data of the processing unit 100. A scheduler 110 is connected to the interconnection unit 102 and to each of the PS modules 106a-m. The scheduler 110 controls the interconnection unit 102 and the PS modules where it schedules the clock cycles. A PS module 106a-m may be implemented by means of a FPGA or an ASIC. As an alternative way, the scheduler 110 may be arranged within the interconnection unit 102. The the data manipulation steps belonging to a specific PS are performed in the specific PS module 106a-m. This is further described below. Different arithmetic operations are performed in each PS module 106a-n and the PS modules are operated in parallel. Thus, the processing unit does not require a processor such as a Digital Signal Processor (DSP).

Process Step (PS)

According to the present invention, different functions where the manipulation of data is performed is extracted and a maximum and an average number of arithmetic operations that each function requires are calculated, wherein a function is a number of data manipulation steps. At least one function is arranged into a group of functions which is called a Process Step (PS) P1-Pm. When a loop is repeated an undetermined number of times, all functions used within the single loop of manipulation steps, have to belong to one single PS. Additionally, it is not allowed to feedback data within a PS. However, when a loop is repeated a predetermined number of times, manipulation steps located in different PS may be used within the loop. Preferably, the operations within one PS may have a substantial similar complexity.

Processing Unit

Each memory in the memory unit has preferably the same size. The size is determined by the PS that requires the most memory. The memory unit 108 comprises at least an in-out memory and at least one processing memory on which the PS operates. Preferably one additional memory is used as an external memory 104. The number of the external memories depends on the amount of data that is to be transferred to the memory and the number of ports of the memories. I.e. it may be one input/output external memory or one input memory and one output memory. The external memory 104 is used for storing data between processing activities. All memories M1-Mn are connected to an interconnection unit 102 and the interconnection unit 102 is always active and interconnects each PS P1-Pm to all memory signals of a respective memory M1-Mn in such a way that each PS P1-Pm is connected to a single memory M1-Mn in the memory unit 106. The interconnection unit 102 is adapted to switch the respective PS from a respective first memory 108a to a respective second memory 108b within one clock cycle at a time point indicated by a scheduler 110. The scheduler 110 controls the interconnection unit 102 and the PS modules 106a-n. Furthermore, the scheduler 110 informs the PS modules when the PS modules are allowed to start to access memories and allowed to start their processing.

The scheduler 110 schedules the actions of the interconnection unit by giving activation orders. During the time between the activation orders (from the scheduler) a PS performs its portion of the algorithm which includes read and write accesses towards the memory within the memory unit that it currently is interconnected to. The number of concurrent read and write accesses during one single clock cycle depends of the number of access ports of the memory. I.e. if the memory has 1 read port and 1 write port, a read and a write access may be performed during one single clock cycle, while a memory with a common read and write port would require two cycles for the same access sequence.

When the process step performs its calculation and data transfer operation, it may perform the access in any order and memory position during its processing period as long as the process step produces the same end product (provided that the same memory content is used) at the end of the period. This is provided that the memory comprises at least two ports; one read port and one write port. However, there also exist other types of memories comprising e.g. a single read/write port, one write port and two read ports. Naturally, it is possible to select these other types of memories but the selected memory type may influence the possible read/write capacity during one clock cycle.

Processing

If K data streams/channels are to be processed within L seconds, then a new data stream/channel enters the processing unit 100 every L/K seconds. I.e. the processing of each PS 106a-n is limited to L/K seconds, and the entire data stream is processed within L*m/K seconds where m is the number of PS.

If the units, which transfer the data (e.g. a channel) between the external memory 104 and the internal memories 108a-n within the memory unit 108 are considered as one or more PS's, the number of PS is equal to the number of internal memories 108a-n. I.e. the first PS transfers data from the external memory 104 to an internal memory 108a-n within the memory unit 108 and the last PS transfers data from an internal memory 108a-n within the memory unit 108. If the memories 108a-n comprises more than one port, or if there exists enough cycles to perform input and output transfers in one sequence, it is possible to merge the first and last PS into one combined input and output PS.

In the example below illustrated in FIG. 2a-2f it is assumed that the number of data streams/channels are K, Ch1-ChK, and n=4 and m=4, there exists thus four memories, M1, M2, M3 and M4, and four PS, P1-P4 wherein the first PS, P1, collects data form the external memory to an internal memory and the last PS, P4 collects data from an internal memory to the external memory. All channels have to be processed within L seconds that implies that a new channel enters the processing unit every L/K seconds and preferably, another channel leaves the processing unit every L/K seconds. Hence, each PS has a maximum allowed time of L/K=M. However, the PS modules do not have to utilise the entire maximum allowed time, i.e. each PS module is allowed to use at most M clock cycles.

In FIGS. 2a-2f a processing unit comprising an interconnection unit 102 connected to a memory unit 208 comprising four memories M1-M4, an external memory 204, process step means 206 comprising PS modules P1-P4 and a scheduler 210 that is further connected to said process step means. FIG. 2a-2f illustrate the procedure when a number of data streams, e.g. a number of speech channels, are processed by the processing unit.

FIG. 2a: M1 is connected to P1 and P1 performs its operation, i.e. collects data (Ch1) from the external memory to M1 during a number of clock cycles p (wherein p≦M).

FIG. 2b: After M clock cycles, the scheduler 210 orders the interconnection unit 202 to perform a switching activity which results in that M1 is now connected to P2 and M2 is connected to P1. P1 performs its operations on M2 during p clock cycles, i.e. collecting data (Ch2) from the external memory to M2, and simultaneously, P2 performs its operations on M1 during q clock cycles (q<M).

FIG. 2c: After another M clock cycles, the interconnection unit 102 performs a switching activity which results in that M1 is now connected to P3, M2 is connected to P2 and M3 is connected to P1. P3 performs its operations on M1 during r clock cycles (r≦M) and simultaneously, P2 performs its operations on M2 during q clock cycles and P1 performs its operation, i.e. collects data (Ch3) from the external memory to M3, during p clock cycles.

FIG. 2d: After yet another M clock cycles, the interconnection unit 102 performs a switching activity which results in that M1 is now connected to P4, M2 is connected to P3, M3 is connected to P2 and M4 is connected to P1. P4 performs its operations on M1, i.e. collects data (the processing of Ch1 is now completed) from M1 to the external memory during s clock cycles and simultaneously, P3 performs its operations on M2 during r clock cycles, P2 performs its operation on M3 and P1 performs its operation on M4, i.e. collects data (Ch4) from the external memory to M4.

FIG. 2e: After yet another M clock cycles, the interconnection unit 102 performs a switching activity which results in that M1 is now connected to P1, M2 is connected to P4, M3 is connected to P3 and M4 to P2. P1 performs its operations on M1, i.e. collects data (Ch5) from the external memory to M1 and simultaneously, P2 performs its operations on M4, P3 performs its operation on M3 and P4 performs its operation on M2, i.e. collects data (the processing of Ch2 is now completed) from M2 to the external memory.

FIG. 2f: After yet another M clock cycles, the interconnection unit 102 performs a switching activity which results in that M1 is now connected to P2, M2 is connected to P1, M3 is connected to P4 and M4 to P3. P2 performs its operations on M1 and simultaneously, P3 performs its operations on M4, P4 performs its operation on M3 i.e. collects data (the processing of Ch3 is now completed) from M3 to the external memory and P1 performs its operation on M2, i.e. collects data (Ch6) from the external memory to M2.

Hence, this procedure is repeated in a cyclic way and continues until substantially all N data streams/channels have been processed by P1-P4 respectively. However it is not required that all PS's are active during the entire session. E.g., if the data stream consists of a channel containing speech that is located in one memory, this channel is not processed by a PS that is handling comfort noise. This particular PS is however connected to the memory containing the data stream, although no processing is performed. It should also be noted that the number of clock cycles denoted as p, q etc. are not fixt. The number depends of the type of data within the data stream/channel. However, it is required that the number is less or equal to M.

Interconnection

A memory unit comprises one or several memories. Each memory comprises a control bus, one or several address busses and one or several read/write data busses. Each PS has a connection to exactly one of those memories. The connection is handled by the interconnection unit. At a beginning of a time period, each PS is switched to another memory by the interconnection unit. The interconnection unit switches all the memory signals such as read/write data, control and address busses from the first PS to the next PS. During that time period a memory is only connected to one process step.

Memory Structure

The memory area may be divided for storing four groups of data:
constant data, used during the session,
session data: data that is used and produced during the session and stored between the channel is switched in and out from an internal memory, to the external memory,
global process steps data: data that is used in several PS's and passes from a one PS to another PS and
local process steps data: data that is used temporary within one PS.

Furthermore, each clock cycle may belong to one of two phases, provided that the memories in the memory unit comprise one single port: In a first phase, the data may be moved every second half cycles to and from the interconnection unit and a second phase may be used for internal updates within the PS (P1-Pm).

The present invention is not limited to the above-described preferred embodiments. Various alternatives, modifications and equivalents may be used. Therefore, the above embodiments should not be taken as limiting the scope of the invention, which is defined by the appending claims.

1-12. (canceled)

13. A processing unit (PA) for processing a plurality of data streams by an algorithm divided into a plurality of process steps, said PA comprising:
an interconnection unit comprising means for switching;
Process Step (PS) means comprising at least two PS modules, where each PS module is connected to the interconnection unit and a scheduler connected to said interconnection unit and to each PS module;
a memory unit comprising at least two memories wherein each memory is connected to the interconnection unit;
the interconnection unit further comprising means for providing at least a first connection between one of said memories and one of said PS modules and a second connection between another of said memories and another of said PS modules, wherein the interconnection unit is adapted to connect each memory to each of the PS modules by a switching activity, wherein the switching activity and the processing of the PS modules are controlled by the scheduler; and
each memory comprises means for storing a data stream and said stored data streams are manipulated in parallel by the connected PS modules respectively, during a predetermined time period between said switching activities.

14. The Processing Unit (PA) according to claim 13, further comprising at least one external memory for storing at least input and output data for the memories within the memory unit.

15. The Processing Unit (PA) according to claim 13, wherein said data streams are channels in a communication system.

16. The Processing Unit (PA) according to claim 13, wherein said channels are speech channels and said PA is implemented in a speech coder.

17. The Processing Unit (PA) according to claim 13, wherein said process step modules are implemented by means of hardware suitable for the algorithm.

18. The Processing Unit (PA) according to claim 13, wherein at least one of the PS modules transfer data between the external memory and any of the memories within the memory unit.

19. A method for processing a plurality of data streams by an algorithm divided into a plurality of Process Steps (PS) by using an interconnection unit comprising means for switching, Process Step (PS) means comprising at least two PS modules, each connected to the interconnection unit and a scheduler connected to said interconnection unit and to each PS module, said method comprising the steps of:
connecting at least two memories within a memory unit to the interconnection unit;
providing by the interconnection unit a first connection between one of said memories and one of said PS modules and a second connection between another of said memories and another of said PS modules, wherein the interconnection unit is adapted to connect each memory to each of the PS modules by a switching activity, wherein the switching activity and the processing of the PS modules are controlled by the scheduler;
storing a data stream in each memory, and
manipulating said data streams in parallel by the connected PS modules respectively, during a predetermined time period between said switching activities.

20. The method according to claim 19, wherein the method comprises the further step of storing at least input and output data for the memories within the memory unit at the at least one external memory.

21. The method according to claim 19, wherein said data streams are channels in a communication system.

22. The method according to claim 21, wherein said channels are speech channels and that said processing unit is implemented in a speech coder.

23. The method according to claim 19, wherein said process step modules are implemented by means of hardware suitable for the algorithm.

24. The method according to claim 19, wherein at least one of the PS modules transfers data between the external memory and any of the memories within the memory unit.
